(19) United States
(12) Patent Application Publication
(10) Pub. No.: US 2026/0183728 A1
(43) Pub. Date: Jul. 2, 2026

(54) THERMAL MIXER AND DEVICE HAVING FLUIDS TO BE MIXED USED IN THERMAL MIXER

(71) Applicant: INDUSTRIAL TECHNOLOGY RESEARCH INSTITUTE, Hsinchu (TW)

(72) Inventors: Hsin-Yi HSU, Taoyuan City (TW); Chang-Chou LI, Tainan City (TW); Yang-Cheng LIN, Chiayi City (TW); Li-Hsin LIN, Zhubei City (TW); Kun-Yen NIEH, Hsinchu City (TW); Yuchi WANG, New Taipei City (TW); Hsin-Hsin SHEN, Zhudong Township (TW)

(73) Assignee: INDUSTRIAL TECHNOLOGY RESEARCH INSTITUTE, Hsinchu (TW)

(21) Appl. No.: 19/005,648

(22) Filed: Dec. 30, 2024

(30) Foreign Application Priority Data
Dec. 27, 2024 (TW) 113151134

(51) Int. Cl. B01F 35/221; B01F 33/453

(52) U.S. Cl. CPC B01F 35/2215; B01F 33/453

(57) ABSTRACT

A temperature-controlled mixing apparatus used to stir a fluid to be mixed in a mixing device at a preset temperature. The mixing device has a magnetic stirrer accommodated therein. The temperature-controlled mixing apparatus includes: a heat exchange module, a magnetic stirring module and a control module. The heat exchange module includes a heat exchange unit and a cooling and/or heating element. The magnetic stirring module includes a magnetic component and a driving component. The driving component is drivingly connected to the magnetic component. The control module is used to control the cooling and/or heating element to adjust the fluids to be mixed to the preset temperature, and drive the driving component to drive the magnetic component to rotate, so that the magnetic component magnetically attracts and drives the magnetic stirrer to rotate and stir the fluid to be mixed.

The present application is based on, and claims priority from, Taiwan Application Serial Number 113151134, filed Dec. 27, 2024, the disclosure of which is hereby incorporated by reference herein in its entirety.

### TECHNICAL FIELD

The technical filed relates to a thermal mixer (also referred as to a temperature-controlled mixing apparatus, thereinafter) and a device having fluids to be mixed (also referred as to a mixing device, thereinafter) used in the thermal mixer.

### BACKGROUND

With the vigorous development of the biomedical industry, a large number of temperature-sensitive biomedical materials and/or biological cells have been used in biological formulation (e.g. the preparations of regenerative medicine (such as, stem cells)). During the administration of the biological formulation, it required at least two biomedical materials evenly mixed to form the biological formulation in a sterile manner, and the mixed biological formulation is then directly used for injection.

However, during the biomedical materials are mixed, variety of biological contaminants may easily occur, and the biological cells in the biological formulation may be easily ruptured to losing the cell activity, due to excessive internal pressure. In addition, the environment of the mixing process is not easy to control at a constant temperature, which may cause the mixed biological formulation denatured, due to excessively high temperatures.

Therefore, there is a need to provide an advanced temperature-controlled mixing apparatus and a mixing device suitable for the temperature-controlled mixing apparatus.

### SUMMARY OF THE DISCLOSURE

One embodiment of the present disclosure is to provide a temperature-controlled mixing apparatus used to stir a fluid to be mixed in a mixing device at a preset temperature. Wherein the mixing device includes a magnetic stirrer accommodated therein. The fluid to be mixed includes a first thermo-sensitive material and a second material. The temperature-controlled mixing apparatus includes a heat exchange module, magnetic stirring module and control module. The heat exchange module includes a heat exchange unit and a cooling and/or heating element. The heat exchange unit includes a heat conducting element thermally coupled to the mixing device. The cooling and/or heating element is thermally coupled to heat conducting element. The magnetic stirring module includes a magnetic component and a driving component. The magnetic component is spaced apart from and positioned around the mixing device, used for magnetically coupling to the magnetic stirrer. The driving component is drivingly connected the magnetic component, and is used to drive the magnetic component to rotate relative to the mixing device. The control module is communicatively connected with the cooling and/or heating element and the driving component, and is used to control the cooling and/or heating element to adjust the fluids to be mixed in the mixing device to the preset temperature, and drive the driving component to rotate the magnetic component, so that the magnetic component magnetically attracts and drives the magnetic stirrer to rotate and stir the fluid to be mixed.

Another embodiment of the present disclosure is to provide a mixing device is suitable for the temperature-controlled mixing apparatus as described above, wherein the mixing device includes fluids to be mixed, a magnetic stirrer and a device body. The fluids to be mixed include a first thermo-sensitive material and a second material. The device body is configured to contain the fluids to be mixed and the magnetic stirrer, and thermally couple with the heat conducting element of the temperature-controlled mixing apparatus while spaced apart from the magnetic component.

The above and other aspects of the disclosure will become better understood by the following detailed description of the preferred but non-limiting embodiment(s). The following description is made with reference to the accompanying drawings:

### BRIEF DESCRIPTION OF THE DRAWINGS

FIG. 1A is a perspective view illustrating a temperature-controlled mixing apparatus and a mixing device according to one embodiment of the present disclosure;

FIG. 1B is a perspective view illustrating the partial components of the temperature-controlled mixing apparatus and the mixing device according to FIG. 1A;

FIG. 1C is a cross-sectional view illustrating the partial components of the temperature-controlled mixing apparatus and the mixing device according to FIG. 1A;

FIG. 1D is a perspective view illustrating the mixing device according to FIG. 1A;

FIG. 1E is a perspective view illustrating a heat exchange unit and its auxiliary thermal insulation unit;

FIG. 2A is a perspective view illustrating a magnetic stirring module assembled in the temperature-controlled mixing apparatus, in which some components are omitted;

FIGS. 2B and 2C are partial side views of the temperature-controlled mixing apparatus respectively illustrating the states when the magnetic stirring module is operated at different heights;

FIG. 2D is a perspective view illustrating some components of the magnetic stirring module according to FIG. 2A;

FIG. 3A is a perspective view illustrating a temperature-controlled mixing apparatus and the mixing device, which omits some components, according to another embodiment of the present disclosure;

FIG. 3B is a partial side view of the temperature-controlled mixing apparatus according to FIG. 3A; and

FIG. 3C is a partial side view illustrating the partial structure of the temperature-controlled mixing apparatus including a magnetic stirring module but omitting some structure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF THE DISCLOSURE

The present disclosure discloses a temperature-controlled mixing apparatus and a mixing device applied in the temperature-controlled mixing apparatus. The temperature-controlled mixing apparatus and the mixing device disclosed in the embodiment are characterized in that a magnetic stirrer is placed in the mixing device containing a first thermo-sensitive material (e.g. biological cells or other thermo-sensitive biomedical materials), and the mixing device is placed within a heat exchange module, which includes a heat exchange unit and a cooling and/or heating element to perform heat exchange with the mixing device, so as to correspondingly control the temperature of the first thermo-sensitive material contained in the mixing device. The temperature of the first thermo-sensitive material contained in the mixing device can be thus adjustable and controllable to maintain a mixing environment with a constant temperature. At the same time, the magnetic component of the magnetic stirring module drives the magnetic stirrer contained in the mixing device to rotate by magnetic attraction (magnetic force), and the rotation speed of the magnetic component is regulated by the control module. Such that, the thermo-sensitive biomedical materials and/or biological cells can be fully mixed in a closed sterile environment without applying excessive mechanical stress and pressure to the thermo-sensitive biomedical materials. In order to make the embodiments and other purposes, features and advantages of the present disclosure more clearly understood, several embodiments of the present disclosure are disclosed below with reference to accompanying drawings.

However, the structure and contents disclosed in the embodiments are for exemplary and explanatory purposes only, and the scope of protection of the present disclosure is not limited to the embodiments. It should be noted that the present disclosure does not illustrate all possible embodiments, and anyone skilled in the technology field of the disclosure will be able to make suitable modifications or changes based on the specification disclosed below to meet actual needs without breaching the spirit of the disclosure. The present disclosure is applicable to other implementations not disclosed in the specification. In different embodiments and drawings, the same elements will be designated by the same reference numerals.

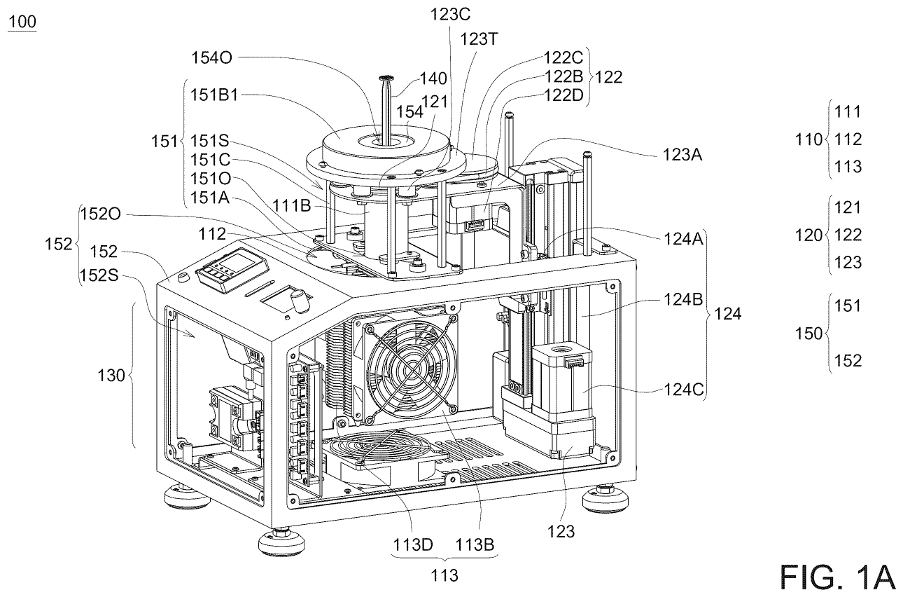

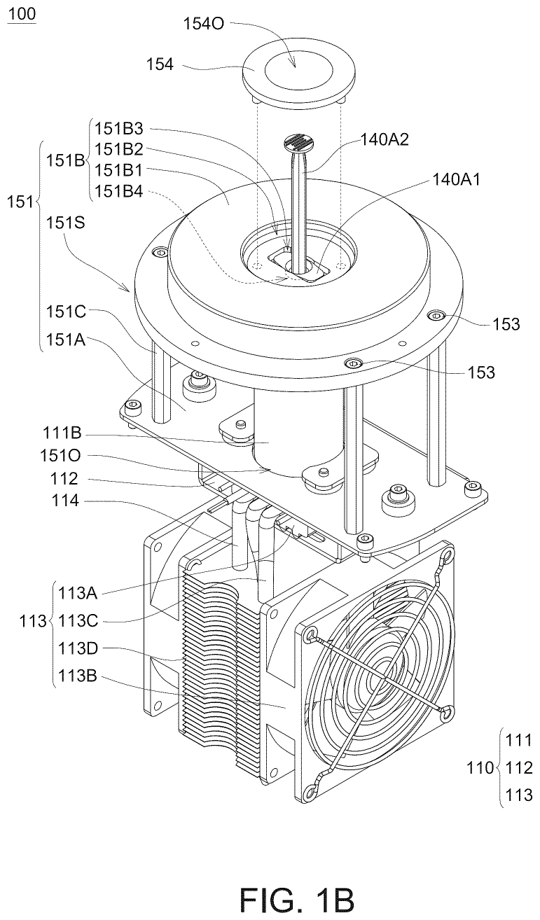

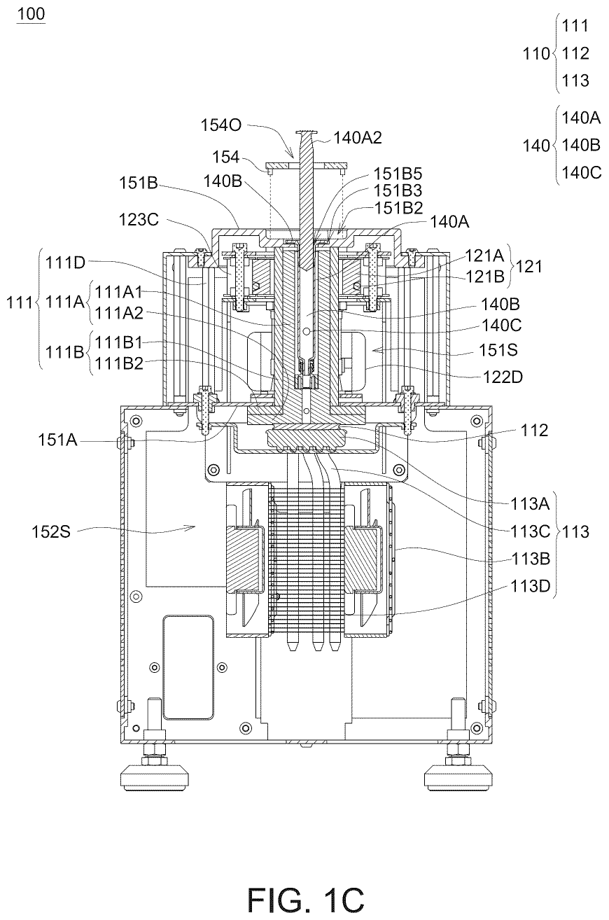

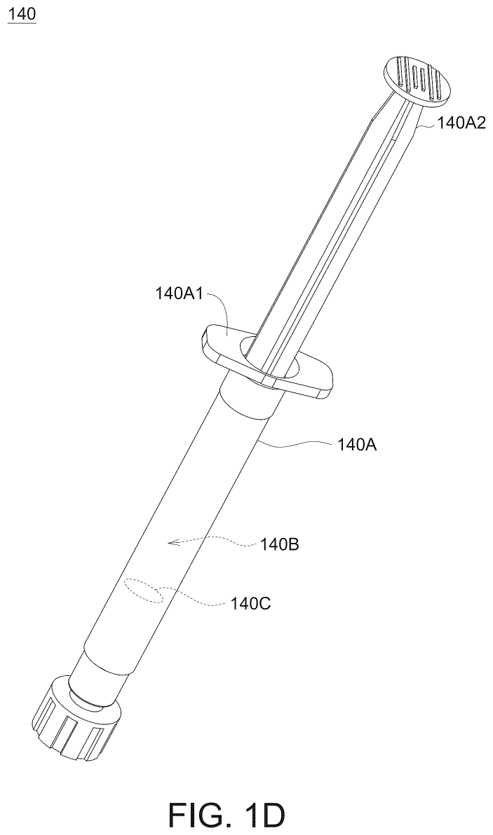

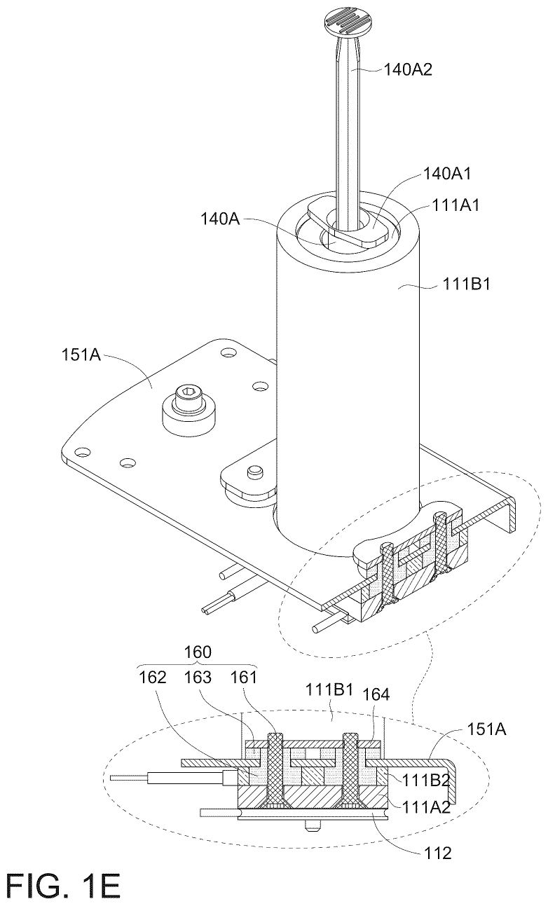

Referring to FIGS. 1A to 1D, FIG. 1A is a perspective view illustrating a temperature-controlled mixing apparatus 100 and a mixing device 140 according to one embodiment of the present disclosure; FIG. 1B is a perspective view illustrating the partial components of the temperature-controlled mixing apparatus 100 and the mixing device 140 according to FIG. 1A; FIG. 1C is a cross-sectional view illustrating the partial components of the temperature-controlled mixing apparatus 100 and the mixing device 140 according to FIG. 1A; and FIG. 1D is a perspective view illustrating the mixing device 140 according to FIG. 1A.

The temperature-controlled mixing apparatus 100 includes a housing unit 150, a heat exchange module 110, a magnetic stirring module 120 and a control module 130, which is used to stir fluids to be mixed 140B contained in the mixing device 140 at a preset temperature.

The mixing device 140 includes a device body 140A, a fluid to be mixed 140B, and a magnetic stirrer 140C; wherein the device body 140A is provided for accommodating the fluid to be mixed 140B, and the magnetic stirrer 140C therein. In one embodiment of the present disclosure, the device body 140A may be a drug delivery device for delivering thermo-sensitive materials, such as a syringe, and its general structure includes a hollow cylindrical barrel (not separately labeled), a flange 140A1 formed at the rear end of the barrel, and a push rod 140A2 that can be sleeved in the barrel and slide along the axial direction of the barrel. The fluid to be mixed 140B and the magnetic stirrer 140C are contained in the barrel of the device body 140A.

The fluid to be mixed 140B may be a liquid fluid, a solid fluid, a liquid-solid fluid or a liquid-gas fluid that includes a first thermo-sensitive material and a second material (not separately labeled) needs to be mixed or stirred. In one embodiment, the device body 140A of the mixing device 140 can be pre-loaded with one of the first thermo-sensitive material and the second material, and the other of the first thermo-sensitive material and the second material can be then injected/filled into the device body 140A according to usage requirements (for example, during surgery), so that the device body 140A of the mixing device 140 can accommodate the fluid to be mixed 140B including the first thermo-sensitive material and the second material.

The first thermo-sensitive material is, for example, a thermo-sensitive biomedical material. Specifically, the first thermo-sensitive material includes an injectable gel (e.g., a highly biocompatible collagen) that is in a flowable state below a threshold temperature (e.g., the human body temperature) and alternatively is in a non-flowable state above the threshold temperature. Of note that, in one embodiment, the preset temperature is lower than the threshold temperature. The second material is, for example, a biological cell. Specifically, the second thermo-sensitive material may include stem cells used in regenerative medicine or living cells, interstitial cells, culture medium or other operating solutions used in other biomedical fields, but it is not limited thereto in the present disclosure.

In one embodiment, the magnetic stirrer 140C is, for example, a permanent magnet that is axially magnetized and has an N-type magnetic pole and an S-type magnetic pole at its opposite ends, and is used to stir various liquid fluids, solid fluids, liquid-solid fluids or liquid-gas fluids. The magnetic stirrer 140C may be shaped like a rod, column, capsule, star-like shape, or any disk-like shape, but is not limited thereto. In some embodiments of the present disclosure, the outer surface of the magnetic stirrer 140C may be coated with a protective coating (such as, a Teflon coating) to increase the waterproofness and durability of the magnetic stirrer 140C.

The housing unit 150 is used to accommodate the heat exchange module 110, the magnetic stirring module 120 and the control module 130, and includes an upper frame assembly 151 and a lower frame assembly 152. The upper frame assembly 151 includes a carrying board 151A, a bracket 151B spaced apart from the carrying board 151A, and a plurality of support members 151C that are disposed between the carrying board 151A and the bracket 151B to make the carrying board 151A and the bracket 151B relatively arranged to each other. Wherein, the carrying board 151A has a mounting hole 1510 that penetrates along an axial direction parallel to the vertical axis. The bracket 151B includes a bracket body 151B1 and a limiting groove 151B2 axially extending and passing through the bracket body 151B1. The limiting groove 151B2 has a first groove portion 151B3 and a second groove portion 151B4 which are sequentially arranged along the axial direction. The first groove 151B3 is arranged at the top side used for allowing the flange 140A1 of the device body 140A of the mixing device 140 to against abut thereon. The second groove 151B4 is arranged at the bottom side used for allowing the barrel of the device body 140A of the mixing device 140 inserting therein. The carrying board 151A, the bracket 151B and the support members 151C assembled together by the upper frame assembly 151 can jointly define a first working space 151S. In the present embodiment, the support members 151C are screwed to the carrying board 151A and the bracket 151B respectively through a plurality of screw lock members 153, however, the present disclosure is not limited thereto. In some embodiments, the support members 151C may be assembled and fixed to the carrying board 151A and the bracket 151B respectively by welding or bonding.

The lower frame assembly 152 is assembled on the bottom side of the upper frame assembly 151, and can define a second working space 152S, and includes at least one through hole 1520 connected to the second working space 152S.

In some embodiments of the present disclosure, the housing unit 150 may selectively include a cover plate 154 having an opening 1540 extending there through in the axial direction. The cover plate 154 is detachably disposed in the limiting groove 151B2, and the opening 1540 allows the push rod 140A2 of the mixing device 140 to pass through, so as to assist in limiting the flange 140A1 of the mixing device 140 to the first groove portion 151B3 of the limiting groove 151B2 to prevent the mixing device 140 from shifting or detaching during the mixing process.

The heat exchange module 110 includes a heat exchange unit 111, a cooling and/or heating element 112, and a heat dissipation unit 113, and is used for thermally coupled to the mixing device 140 to perform heat exchange therewith. In some embodiments of the present disclosure, the heat exchange unit 111 may include a heat conducting element 111A and a heat insulation element 111B.

The heat conducting element 111A is generally cylindrical and is made of a heat conducting material (such as metal in one embodiment), and includes a first conducting portion 111A1 assembled in the first working space 151S of the upper frame assembly 151 and penetrating through the mounting hole 1510 of the carrying board 151A, and a second conducting portion 111A2 integrally formed at the bottom side of the first conducting portion 111A1 and located in the second working space 152S. Wherein, the top opening of the first conducting portion 111A1 corresponds to the limiting groove 151B2 of the bracket 151B, and allows at least a part of the mixing device 140 inserted therein for thermal coupling. In some embodiments of the present disclosure, the cross-sectional area of the second conducting portion 111A2 along the radial direction is larger than the cross-sectional area of the first conducting portion 111A1 along the radial direction, so as to increase the thermal coupling area and improve the heat exchange efficiency. The heat insulating element 111B is made of at least one heat insulating material (such as, styrofoam and/or thermal insulation cotton), and its shape corresponds to the heat conducting element 111A. The heat insulating element 111B also includes a first insulating portion 111B1 and a second insulating portion 111B2 used to isolate the heat conducting element 111A from the external environment. Wherein, the first insulating portion 111B1 covers on the outside of the first conducting portion 111A1 with a shape similar to the configuration of the first conducting portion 111A1, and is assembled in the first working space 151S, and passes through the installation hole 1510 of the carrying board 151A. The second insulating portion 111B2 is integrally formed on the bottom side of the first insulating portion 111B1 and is sandwiched between the carrying board 151A and the second conducting portion 111A2.

In some other embodiments of the present disclosure, the heat exchange unit 111 may further include at least one auxiliary thermal insulation unit 160. FIG. 1E is a perspective view illustrating a heat exchange unit 111 and its auxiliary thermal insulation unit 160. The auxiliary thermal insulation unit 160 includes a first auxiliary heat insulating element 162, a second auxiliary heat insulating element 163, a first fixing member 161 and a second fixing member 164. The first auxiliary heat insulating element 162 (in one embodiment, for example, may be a flanged insulation collar/washer) is made of heat insulating material, which is assembled in the second insulating portion 111B2 and partially protrudes out of the carrying board 151A. The second auxiliary heat insulating element 163 (in one embodiment, for example, may be a gasket-shaped insulation collar/washer) is also made of heat insulating material, which is sleeved on the first auxiliary heat insulating element 162 and sandwiches the carrying board 151A with the first auxiliary heat insulating element 162. The first fixing member 161 and the second fixing member 164 are correspondingly assembled together to fix the first auxiliary heat insulating element 162 and the second auxiliary heat insulating element 163 to the second conducting portion 111A2, the second insulating portion 111B2 and the carrying board 151A. In one embodiment, the first fixing member 161 is, for example, a flat head screw, and the second fixing member 164 is, for example, a locking plate, but the present disclosure is not limited thereto. In addition, although in the present embodiment, the number of auxiliary heat insulating units 160 is two, and they are respectively arranged in a ring shape relative to the axis of the heat conducting element 111A and the heat insulating element 111B, but in some embodiments, the auxiliary heat insulation unit 160 can be alternatively configured in different quantities and configurations according to design requirements, which are described in detail herein. By the mechanical design of the auxiliary thermal insulation unit 160, the heat conducting element 111A and the heat insulating element 111B can be stably mounted on the carrying board 151A; and the auxiliary thermal insulation unit 160 together with the heat insulating element 111B can isolate the heat conducting element 111A from the external environment.

The cooling and/or heating element 112 is disposed in the second working space 152S of the lower frame assembly 152, is thermally coupled to the bottom side of the second conducting portion 111A2 of the heat conducting element 111A, and is in communication connection with the control module 130. The control module 130 can send a signal to adjust the working temperature of the cooling and/or heating element 112, thereby cooling and/or heating the heat conducting element 111A and the mixing device 140 inserted therein to a preset temperature. In some embodiments of the present disclosure, the cooling and/or heating element 112 may include a thermoelectric cooling chip, which utilizes the Peltier effect of the semiconductor material of the thermoelectric cooling chip. When direct current passes through a plurality of electric couplers composed of two semiconductor materials with different electrical conductivities (P-type semiconductor bumps and N-type semiconductor bumps) connected in series (not shown), heat can be absorbed and released at both ends of the electric coupler, respectively, so as to provide cooling and/or heating functions.

The heat dissipation unit 113 is also accommodated in the second working space 152S, and includes a heat sink 113A, a fan assembly 113B, a heat pipe assembly 113C, and a fin assembly 113D, for dissipating heat from the cooling and/or heating element 112, the heat conduction element 111A and the mixing device 140. The two opposite ends of the heat sink 113A are thermally coupled to the cooling and/or heating element 112 and the heat pipe assembly 113C respectively. The heat pipe assembly 113C is thermally coupled to the fin assembly 113D at its side away from the heat sink 113A. The fan assembly 113B is spaced apart from and arranged on the relatively outer side of the heat pipe assembly 113C and the fin assembly 113D and separating them for a distance, and the assembly position of the fan assembly 113B corresponds to the through hole (not separately labeled) of the lower frame assembly 152 for promoting heat convection in the second working space 152S and exhaust air from the through hole. The fan assembly 113B is communicatively connected to the control module 130, and the control module 130 can send a signal to control the rotation of the fan assembly 113B. In the present embodiment, although the heat dissipation unit 113 is composed of one heat sink 113A, one fan assembly 113B having a plurality of fans, one heat pipe assembly 113C having a plurality of heat pipes, and one fin assembly having a plurality of fins, but the present disclosure is not limited thereto. In some embodiments, the structure and the number of components of the heat dissipation unit 113 can be altered according to design requirements (such as, heat dissipation efficiency), which will not be described in detail here.

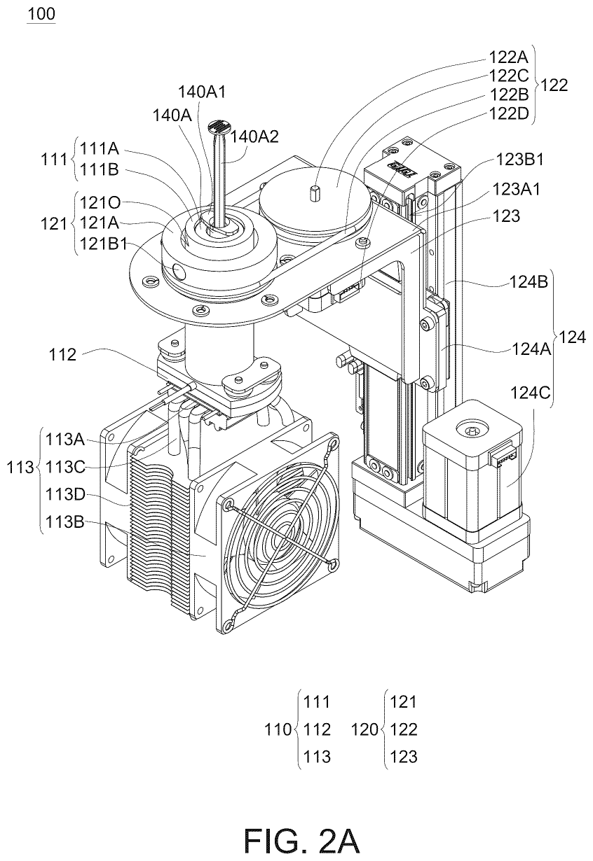

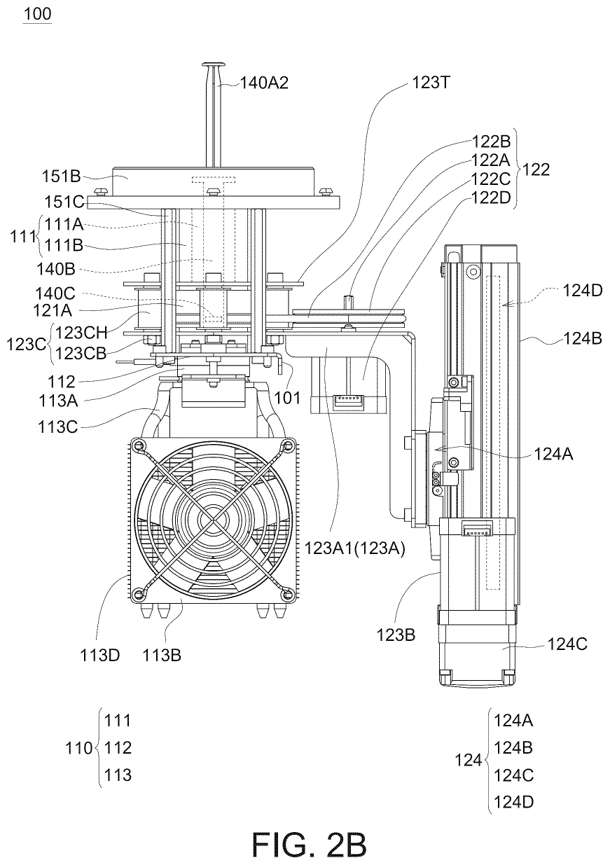

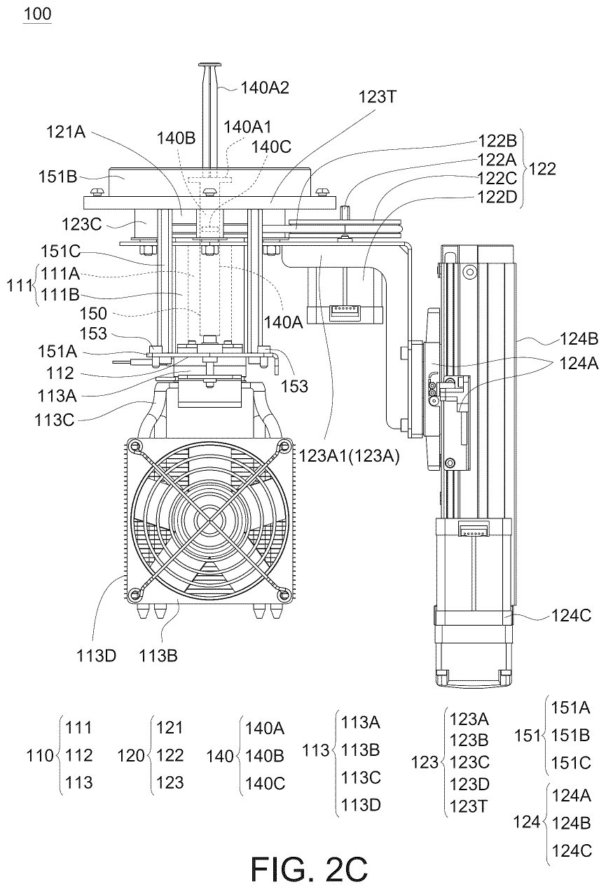

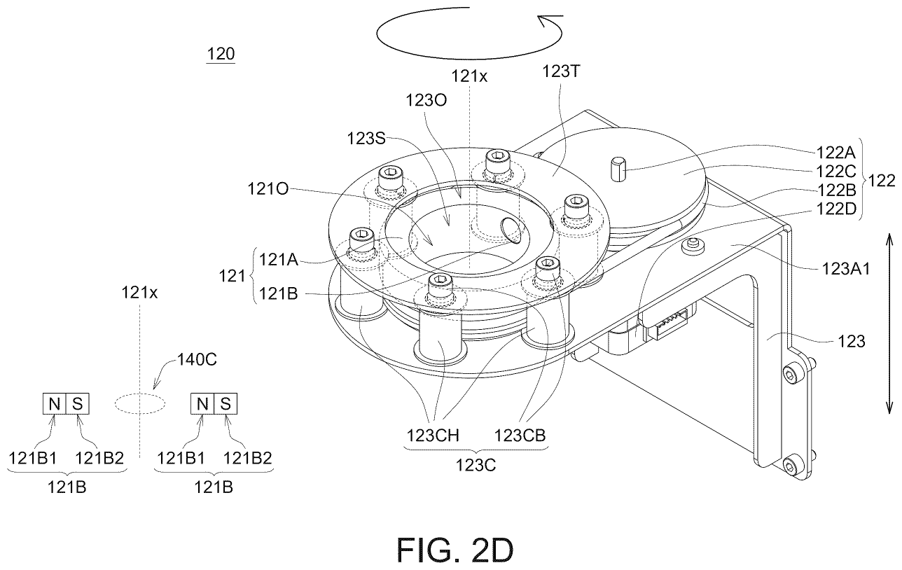

Referring to FIGS. 2A to 2D, FIG. 2A is a perspective view illustrating a magnetic stirring module 120 assembled in the temperature-controlled mixing apparatus 100, in which some components are omitted; FIGS. 2B and 2C are partial side views of the temperature-controlled mixing apparatus 100 respectively illustrating the states when the magnetic stirring module 120 is operated at different heights; and FIG. 2D is a perspective view illustrating some components of the magnetic stirring module 120 according to FIG. 2A. As shown in the FIGs, the magnetic stirring module 120 includes a magnetic component 121, a driving component 122 and a supporting component 123, and is used to drive the magnetic stirrer 140C contained in the mixing device 140 to rotate at least one preset speed via magnetic attraction (magnetic force).

The magnetic component 121 surrounds but separates from the heat exchange unit 111 and the mixing device 140 that is inserted in the heat exchange unit 111, and includes an annular rotor 121A and a magnet unit 121B. The annular rotor 121A has an opening 1210 which penetrates along the axial direction and allows the heat exchange unit 111 and the mixing device 140 to pass there through. The magnet unit 121B may include at least one N (north-pole) magnetic member 121B1 and at least one S (south-pole) magnetic member 121B2 embedded in the annular rotor 121A and arranged opposite to each other, used for magnetically coupling to the magnetic stirrer 140C contained in the mixing device 140. The N magnetic member 121B1 and the S magnetic member 121B2 have the same number, shape, size and magnetic field. In the present embodiment, the N magnetic member 121B1 and the S magnetic member 121B2 are, for example, a pair of magnets with opposite poles and magnetically coupled to the magnetic stirrer 140C. However, in the present disclosure, the number of N magnetic member 121B1 and the S magnetic member 121B2 is not limited to. In some other embodiments, the number of the N magnetic member 121B1 and the S magnetic member 121B2 may be greater than two. In addition, in one embodiment, the N magnetic member 121B1 and the S magnetic member 121B2 can be permanent magnets, such as magnets made of rare earth metals or neodymium iron boron magnets, and the magnetic attraction (magnetic force) caused by the N magnetic member 121B1 and the S magnetic member 121B2 is greater than the magnetic attraction (magnetic force) caused by the magnetic poles (S/N) of the magnetic stirrer 140C.

The driving component 122 includes a belt 122B, a belt driving wheel 122C connected to the annular rotor 121A through the belt 122B, and a driving motor 122D having a rotating shaft 122A pivotally connected with the belt driving wheel 122C. The driving component 122 is used to drive the annular rotor 121A of the magnetic component 121 to rotate relative to the heat exchange unit 111 and the mixing device 140. The driving motor 122D is communicatively connected to the control module 130, and the control module 130 can send a signal to control the rotation of the driving motor 122D. In the present embodiment, although the driving component 122 drives the magnetic component 121 to rotate by the belt 122B, the belt driving wheel 122C and the driving motor 122D, but the form of the driving component 122 in the present disclosure is not limited thereto. For example, in some other embodiments, the driving component 122 may also be in any form that can cause the magnetic component 121 to rotate relative to the heat exchange unit 111 and the mixing device 140. When the control module 130 controls the driving motor 122D to rotate; the rotating shaft 122A pivoted with the driving motor 122D can drive the belt driving wheel 122C to rotate; and the belt 122B drives the annular rotor 121A of the magnetic component 121 and the magnet unit 121B to rotate relative to the heat exchange unit 111 and the mixing device 140.

Please refer to FIG. 1A, the supporting component 123 is assembled on the housing unit 150, and includes a supporting base 123A for assembling the magnetic component 121 and the driving component 122, and a vertical bracket 123B. One end of the vertical bracket 123B is disposed on the lower frame assembly 152, and the other end is assembled with the supporting base 123A. The supporting base 123A includes a platform 123A1, a mounting plate 123T and a plurality of holding members 123C. The platform 123A1 is generally in the shape of an inverted L and is assembled with the vertical bracket 123B. The mounting plate 123T is roughly in an annular shape. The holding members 123C are disposed between the platform 123A1 and the mounting plate 123T and are spaced apart from each other. The platform 123A1 partially protrudes from the first working space 151S and has a through hole 1230 corresponding to the limiting groove 151B2 of the bracket 151B and allowing the heat exchange unit 111, the mixing device 140 and the magnetic component 121 pass there through. Each of the holding members 123C has a main body 123CB and a holding portion 123CH (e.g., a support wheel). Wherein the holding members 123C has opposite ends respectively passing through the platform 123A1 and the mounting plate 123T; and the holding portion 123CH is disposed on the main body 123CB and allowing the top outer edge and the bottom outer edge of the annular rotor 121A of the magnetic component 121 to abut thereon. Thereby, the annular rotor 121A of the magnetic component 121 can be rotatably fixed between the fixing portions 123CH of the plural holding members 123C surrounding the annular rotor 121A. The belt 122B and the belt driving wheel 122C of the driving component 122 are arranged on the top side of the carrier 123A1 in cooperation with the annular rotor 121A of the magnetic assembly 121. The driving motor 122D is arranged on the bottom side of the platform 123A1 and its rotating shaft 122A passes through the platform 123A1 to be pivotally connected with the belt drive wheel 122C. At this time, the top outer edge and the bottom outer edge of the annular rotor 121A are in movable contact with the holding portions 123CH of the holding members 123C, and are spaced apart from (i.e., not in contact with) the platform 123A1 and the mounting plate 123T. In the present embodiment, there are, for example, six holding members 123C to stably fix the annular rotor 121A; however, in the present disclosure, the number of the holding members 123C is not limited. In some other embodiments, the number of the holding members 123C may be two to five, or more than six, as long as the annular rotor 121A can be rotatably fixed there between.

In some embodiments of the present disclosure, the supporting component 123 may further include a lifting assembly 124 disposed between the supporting base 123A and the vertical bracket 123B to drive the supporting base 123A to move relative to the vertical bracket 123B, for example, in a vertical direction. Thereby, the supporting base 123A and the magnetic component 121 can also be moved in the vertical direction (i.e., the axial direction of the magnetic component 121 and the heat exchange unit 111) relative to the heat exchange unit 111 and the mixing device 140. Synchronously, the magnet unit 121B of the magnetic component 121 drives the magnetic stirrer 140C contained in the mixing device 140 to move in the vertical direction by the magnetic attraction (magnetic force).

The lifting assembly 124 includes a first sliding member 124A, a second sliding member 124B and a lifting driver 124C. The first sliding member 124A (for example, a slider) is coupled to the side of the supporting base 123A facing to the vertical bracket 123B. The second sliding member 124B (for example, the guide groove) is mounted on the vertical bracket 123B and can be slidably assembled with the first sliding member 124A correspondingly. The lifting driver 124C is connected to the first sliding member 124A, and is used to drive the first sliding member 124A to slide vertically relative to the second sliding member 124B. (In one embodiment, for example, the lifting assembly 124 is a linear slide including a ball screw, a ball nut, a belt and a lifting motor). The lifting driver 124C can be communicatively connected to the control module 130, and the control module 130 can send a signal to control the movement of the lifting driver 124C. By using the control module 130 to control the lifting driver 124C, the supporting base 123A and the first sliding member 124A can slide in the vertical direction relative to the second sliding member 124B, thereby adjusting the vertical height of the magnetic component 121 relative to the magnetic stirrer 140C contained in the mixing device 140; and then driving the magnetic stirrer 140C to change the height position at which stirring is performed within the mixing device 140, by the magnetic attraction (force).

Please refer to FIGS. 1A, 2B, and 2C, the control module 130 is installed in the housing unit 150 and is connected to the cooling and/or heating element 112 and the fan assembly 113B of the heat exchange module 110 to adjust the working temperature of the cooling and/or heating element 112 so that the fluid to be mixed 140B in the mixing device 140 can be mixed at a preset temperature. The control module 130 is also communicatively connected with the driving motor 122D of the driving component 122 of the magnetic stirring module 120, and is used to correspondingly adjust the mixing speed and mixing time of the magnetic component 121 and its magnet unit 121B relative to the magnetic stirrer 140C contained in the mixing device 140 for mixing materials. The control module 130 is also connected to the lifting driver 124C of the lifting assembly 124 of the magnetic stirring module 120 for correspondingly adjusting the mixing position of the magnetic component 121 and its magnet unit 121B relative to the magnetic stirrer 140C contained in the mixing device 140.

When the control module 130 controls the lifting driver 124C of the lifting assembly 124 to drive the first sliding member 124A, the supporting base 123A, and the magnetic component 121 to slide downward or upward in the vertical direction, and controls the driving motor 122D of the driving component 122 to rotate the magnetic component 121 and its magnet unit 121B; the magnetic stirrer 140C contained in the mixing device 140, that is affected by the magnetic attraction of the magnet unit 121B of the magnetic component 121, can also descend or move upward and/or rotate synchronously, and the fluid to be mixed 140B in the mixing device 140 can be mixed up and down, thereby the mixing uniformity and mixing efficiency can be improved. During the mixing process, the control module 130 can also be used to control the cooling and/or heating elements 112 and/or the fan assembly 113B to maintain the mixing operation performed at a preset temperature to prevent the mixing process from conversely affecting the material properties of the liquids to be mixed (for example, causing the thermos-sensitive material denaturation or damage) due to temperature changes.

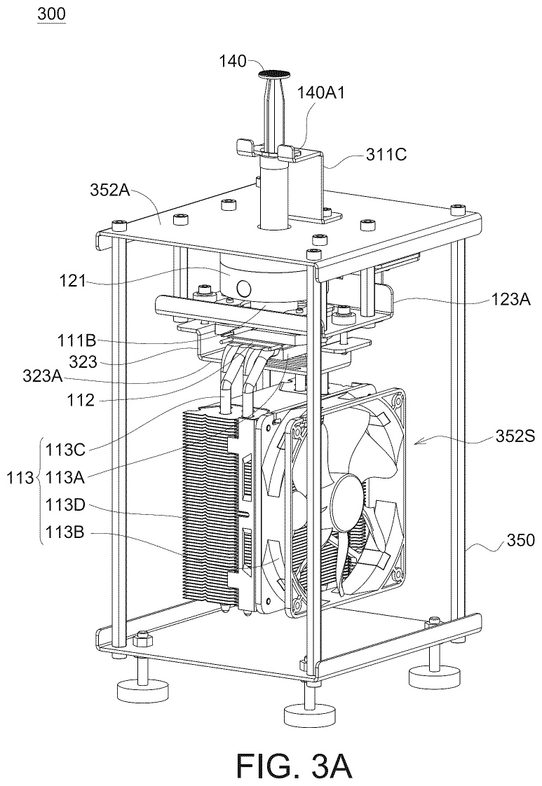

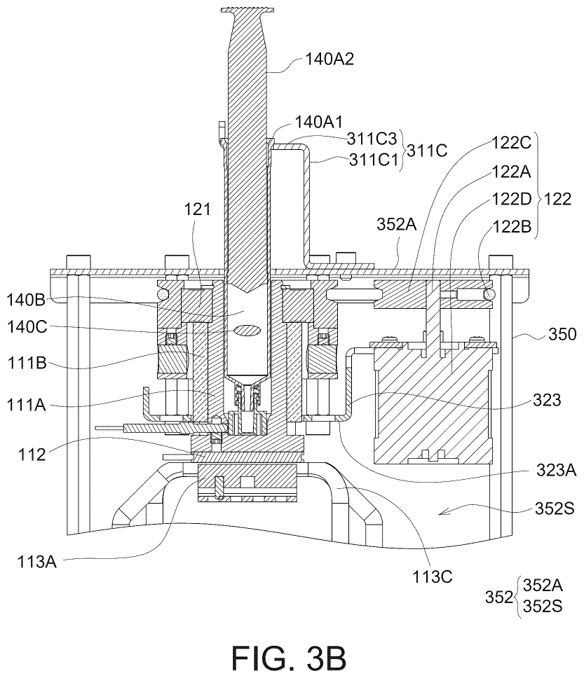

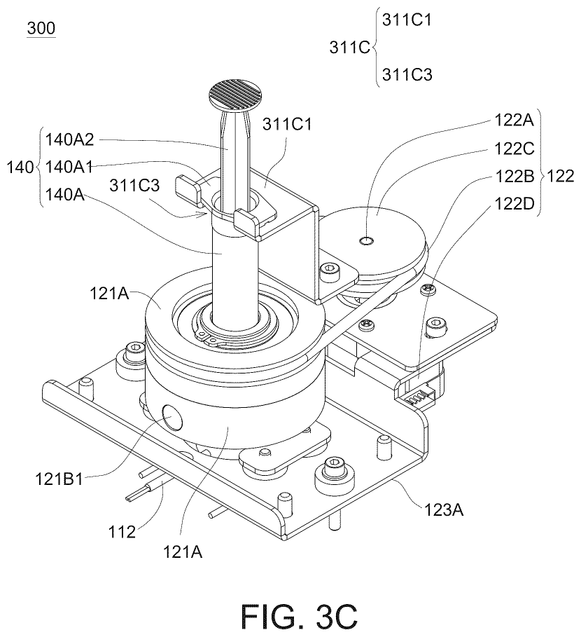

Please refer to FIGS. 3A to 3C, FIG. 3A is a perspective view illustrating a temperature-controlled mixing apparatus 300 and the mixing device 140, which omits some components, according to another embodiment of the present disclosure; FIG. 3B is a partial side view of the temperature-controlled mixing apparatus 300 according to FIG. 3A; and FIG. 3C is a side view illustrating the partial structure of the temperature-controlled mixing apparatus 300 including a magnetic stirring module 120 but omitting some structure. The structure of the temperature-controlled mixing apparatus 300 is similar to that of the temperature-controlled mixing apparatus 100, except that the housing unit 350 of the temperature-controlled mixing apparatus 300 omits the upper frame assembly 151, and the structure of the bracket 311C is different.

In the present embodiment, the magnetic component 121 and the driving component 122 of the magnetic stirring module 120 are fixed in the second working space 352S of the lower frame assembly 352 of the housing unit 350 by the supporting component 323 (including the supporting base 323A). The bracket 311C is an integrally formed and plate-like with continuously bents structure used for supporting and positioning the flange 140A1 of the mixing device 140. The bracket 311C includes a bracket body 311C1 that is approximately in a Z shape, and a stopper 311C3 formed at a free end of the top side of the bracket body 311C1. The bottom side of the bracket body 311C1 is fixed to the carrying board 352A of the lower frame assembly 352 of the housing unit 350. By the structural design of the bracket 311C, the flange 140A1 of the mixing device 140 can be engaged with and limited by the bracket body 311C1 and the stopper 311C3, so as to prevent the mixing device 140 from shifting or detaching during the mixing process.

The following describes a mixing test using the temperature-controlled mixing apparatus 100 to mix the biological cells and biomedical material colloid contained in the mixing device 140; a conventional manual the mixing method using a syringe is also performed under the same conditions; and the mixing effect of the temperature-controlled mixing apparatus 100 can be verified by comparing the test results.

In one embodiment of the present disclosure, the fluid to be mixed (for example, containing 1.8 ml of biomedical material colloid (for example, BIO-INK) and 0.2 ml of mesenchymal stem cells (MSCs)) is added to the mixing device 140, and the mixing device 140 is then placed in the temperature-controlled mixing apparatus 100 for mixing, wherein the speed of the magnetic stirrer 140C is controlled at 30 revolutions per minute (rpm) for 12 minutes. In the control group, a syringe containing the biomedical material colloid was docked with another syringe containing the mesenchymal stem cells, and the mixing of these two is performed by manually pushing the syringe left and right several times (for example, 40 times). Afterwards, the mixture contained in the mixing device 140 and the syringes of the control group are respectively divided into three parts (e.g., upper, middle and lower parts). The contents of the three parts (0.6 ml each) are then taken out for calculating the cell number and survival rate of each part using a cell counter (Adam). The coefficient of variation (CV) of the cell number and survival rate (CV=standard deviation (std.)/Mean) was also calculated to estimate the mixing uniformity.

The test results are shown in Table 1 (Embodiments of the present disclosure) and Table 2 (Control Group):

TABLE 1

| | | survival | | | |
|---|---|---|---|---|---|
| | Total cell | rate | | | |
| Embodiments | number | V % | Mean | std. | CV |
| Upper part | 1.72E⁺⁰⁵ | 93% | 1.80E⁺⁰⁵ | 6018.5 | 3.34% |
| Middle part | 1.83E⁺⁰⁵ | 89% | — | — | — |
| Lower part | 1.86E⁺⁰⁵ | 85% | — | — | — |

TABLE 2

| | | survival | | | |
|---|---|---|---|---|---|
| | Total cell | rate | | | |
| Control Group | number | V % | Mean | std. | CV |
| Upper part | 2.20E⁺⁰⁵ | 78% | 2.31E⁺⁰⁵ | 24916 | 10.38% |
| | 2.32E⁺⁰⁵ | 79% | — | — | — |
| Middle part | 2.04E⁺⁰⁵ | 90% | — | — | — |
| | 2.74E⁺⁰⁵ | 89% | — | — | — |
| Lower part | 2.51E⁺⁰⁵ | 88% | — | — | — |
| | 2.06E⁺⁰⁵ | 80% | — | — | — |

According to the test results, it can be found that the coefficient of variation (CV) of the three parts contained in the mixing device 140 and mixed using the temperature-controlled mixing apparatus 100 is 3.34%, which is much smaller than the coefficient of variation (CV=10.78%) of the three parts of the control group after manual syringe mixing. The material mixed by the temperature-controlled mixing apparatus 100 has better cell distribution uniformity.

In another embodiment of the present disclosure, another mixing test is performed. 1.8 ml of biomedical material colloid and 0.2 ml of mesenchymal stem cells are respectively filled into two mixing devices 140, and then two temperature-controlled mixing apparatuses 100 are respectively used to perform the mixing process. During the mixing process, the control module 130 is used to turn off the heat exchange module 110 of one of the two temperature-controlled mixing apparatuses 100, and to turn on the heat exchange module 110 of the other temperature-controlled mixing apparatus 100, and the mixing effect with and without temperature control under the same conditions (the speed of the magnetic stirrer 140C is controlled at 30 rpm for 12 minutes) can be figured out by comparing the test results.

The test results are shown in Table 3:

TABLE 3

| Embodiments | Mean | Std. | CV |
|---|---|---|---|
| With temperature control | 5.41E+05 | 1.81E⁺⁰⁴ | 3.34% |
| Without temperature control | 5.53E+05 | 1.89E⁺⁰⁵ | 34.11% |

The test results indicate that after mixing under temperature control, the coefficient of variation (CV) of the three parts is 3.34%, which is significantly lower than the coefficient of variation (CV=34.11%) of the three parts mixed without temperature control.

In yet another embodiment of the present disclosure, yet another mixing test is performed. 1.8 ml of biomedical material colloid and 0.2 ml of mesenchymal stem cells are respectively filled into two mixing devices 140, and then two temperature-controlled mixing apparatuses 100 are respectively used to perform the mixing process. During the mixing process, the control module 130 is used to control the magnetic stirring module 120 of one of the temperature-controlled mixing apparatus 100 to be descend and ascend in reciprocate and relative to its mixing device 140 (as shown in FIGS. 2B and 2C); the magnetic stirring module 120 of another temperature-controlled mixing apparatus 100 is simultaneously controlled to be located at a lower operating position relative to its mixing device 140 (as shown in FIG. 2B); and then the mixing effect can be estimated by visually observing the dye both added in these two devices having fluids to be mixed 140. The test results indicate that the temperature-controlled mixing apparatus 100 that can be slidably moved to different heights (as shown in FIGS. 2B and 2C) can provide better mixing effect.

According to the above embodiments, the present disclosure provides a temperature-controlled mixing apparatus and a mixing device, wherein a first thermo-sensitive material and a magnetic stirrer are accommodated in the mixing device, and the temperature-controlled mixing apparatus provides a heat exchange module and its cooling and/or heating elements to adjust the mixing temperature of the mixing device during the mixing process, so as to maintain a fluid mixing environment with a constant temperature. In addition, the temperature-controlled mixing apparatus provides a magnetic component of the magnetic stirring module and a lifting assembly to adjust the mixing position and mixing speed of the magnetic stirrer of contained in the mixing device during the mixing process. Such that, the thermo-sensitive biomedical materials and/or biological cells can be fully mixed in a closed sterile environment without applying excessive mechanical stress and pressure to the thermo-sensitive biomedical materials.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A temperature-controlled mixing apparatus, used to stir a fluid to be mixed in a mixing device at a preset temperature, wherein the mixing device comprises a magnetic stirrer accommodated therein, and the fluid to be mixed comprises a first thermo-sensitive material and a second material, the temperature-controlled mixing apparatus comprising:
a heat exchange module, comprising:
a heat exchange unit, comprising a heat conducting element thermally coupled to the mixing device; and
a cooling and/or heating element, thermally coupled to the heat conducting element;
a magnetic stirring module, comprising:
a magnetic component, spaced apart from and positioned around the mixing device, and used for magnetically coupling to the magnetic stirrer; and
a driving component, drivingly connected to the magnetic component, and used to drive the magnetic component to rotate relative to the mixing device; and
a control module, communicatively connected with the cooling and/or heating element and the driving component, and used to control the cooling and/or heating element to adjust the fluid to be mixed in the mixing device to the preset temperature, and drive the driving component to rotate the magnetic component, so that the magnetic component magnetically attracts and drives the magnetic stirrer to rotate and stir the fluid to be mixed.

2. The temperature-controlled mixing apparatus of claim 1, wherein the magnetic component comprises:
an annular rotor, allowing the heat exchange unit and the mixing device to pass therethrough and drivingly connected to the driving component; and
a magnet unit, comprising at least one north-pole magnetic member and at least one south-pole magnetic member embedded in the annular rotor, and used for magnetically coupling to the magnetic stirrer contained in the mixing device.

3. The temperature-controlled mixing apparatus of claim 2, wherein the driving component comprises: a belt, a belt driving wheel connected to the annular rotor through the belt, and a driving motor having a rotating shaft pivotally connected with the belt driving wheel; wherein when the control module drives the driving motor to rotate the belt driving wheel, the belt drives the annular rotor and the magnet unit to rotate relative to the heat exchange unit and the mixing device.

4. The temperature-controlled mixing apparatus of claim 1, further comprising a housing unit used to accommodate the heat exchange module, the magnetic stirring module and the control module, wherein the magnetic stirring module further comprises:
a supporting component, comprising:
a supporting base, for assembling the magnetic component and the driving component; and
a vertical bracket, wherein one end of the vertical bracket is disposed on the housing unit and the other end is assembled with the supporting base.

5. The temperature-controlled mixing apparatus of claim 4, wherein the supporting base comprises:
a platform, assembled with the vertical bracket;
a mounting plate, spaced apart from the platform; and
a plurality of holding members, disposed between the platform and the mounting plate, movably contacting with the annular rotor to allow the annular rotor to be rotatably fixed there between.

6. The temperature-controlled mixing apparatus of claim 4, wherein the supporting component further comprises a lifting assembly disposed between the supporting base and the vertical bracket, configured to drive the supporting base to move relative to the vertical bracket in a vertical direction, and synchronously to drive the magnet unit to move the magnetic stirrer contained in the mixing device in the vertical direction via the magnetic attraction.

7. The temperature-controlled mixing apparatus of claim 6, wherein the lifting assembly comprises:
a first sliding member, coupled to a side of the supporting base facing the vertical bracket;
a second sliding member, mounted on the vertical bracket and slidably assembled with the first sliding member correspondingly; and
a lifting driver, connected to the first sliding member, and used to drive the first sliding member to slide vertically relative to the second sliding member.

8. The temperature-controlled mixing apparatus of claim 1, further comprising a heat insulating element covering the heat conducting element, and used to isolate the heat conducting element from an external environment.

9. The temperature-controlled mixing apparatus of claim 8, further comprising an auxiliary thermal insulation unit disposed on the heat conducting element and the heat insulating element, wherein the auxiliary thermal insulation unit and the heat insulating element together isolate the heat conducting element from an external environment.

10. A mixing device, suitable for the temperature-controlled mixing apparatus according to claim 1, comprising:
a fluid to be mixed, comprising a first thermo-sensitive material and a second material;
a magnetic stirrer; and
a device body, configured to contain the fluid to be mixed and the magnetic stirrer, and thermally coupled with the heat conducting element of the temperature-controlled mixing apparatus while spaced apart from the magnetic component.
